(19) United States
(12) Patent Application Publication
(10) Pub. No.: US 2014/0071349 A1
(43) Pub. Date: Mar. 13, 2014

(54) METHOD, APPARATUS, AND COMPUTER PROGRAM PRODUCT FOR CHANGING A VIEWING ANGLE OF A VIDEO IMAGE

(71) Applicants: Anssi Sakari Ramo, Tampere (FI); Adriana Vasilache, Tampere (FI); Petri Jarske, Tampere (FI); Juha Arrasvuori, Tampere (FI)

(72) Inventors: Anssi Sakari Ramo, Tampere (FI); Adriana Vasilache, Tampere (FI); Petri Jarske, Tampere (FI); Juha Arrasvuori, Tampere (FI)

(73) Assignee: NOKIA CORPORATION, Espoo (FI)

(21) Appl. No.: 13/612,336

(22) Filed: Sep. 12, 2012

(51) Int. Cl. H04N 5/268

(52) U.S. Cl. 348/705; 348/E05.057

(57) ABSTRACT

A method, apparatus and computer program product for changing a viewing angle of a video image. An indication to change a viewing angle of a first video image of a subject may be received, and in response, a second video image of the subject, captured from a different angle, is displayed. The indication is detected by user input such as selection of an area of an image, movement of a mobile device, or detection of a user's gaze. Display adjustments may be made by zooming and cropping, and audio adjustments may be made by changing a volume associated with an area of an image, allowing for a customizable viewing experience.

### TECHNOLOGICAL FIELD

An example embodiment of the present invention relates generally to the display of a media image, and more particularly, to a method, apparatus and computer program product for changing a viewing angle of a video image.

### BACKGROUND

The widespread use of social media paired with the advancement of computing technology and mobile devices has led to an increase in video capture and sharing. Many users upload their video footage to social media or other sites for others to view. Often times, various mobile device users capture video footage of the same event, making it difficult for viewers to choose which video image to view.

### BRIEF SUMMARY

A method, apparatus, and computer program product are therefore provided for changing a viewing angle of a video image. In one embodiment, a method is provided for receiving indication to associate a first video image with a second video image, wherein the first and second video images include respective images of a subject, associating the first video image, the second video image and an angle of the second video image relative to the first video image, causing display of the first video image including an image of a subject, receiving indication to change a viewing angle relative to the subject, and causing display of the second video image associated with the first video image including an image of the subject based on the indication to change the viewing angle. The indication to change the angle may be given by a movement of a device such as tilting, or bending. Additionally or alternatively, the indication to change the angle may be received by detecting a gaze of a user, and/or by user selection of an object of interest.

In some embodiments, the method includes receiving indication to associate the first and second video images with an angle of the second video image relative to the first video image, and associating the first video image, second video image, and the angle. According to some embodiments, the method may include receiving indication to change a zoom level or cropping of an image, and causing display of the video image to change based on the indication. In some embodiments, the indication is a change in position of a device relative to a position of a virtual space.

In some embodiments, an apparatus is provided, comprising a processor and memory, the memory including computer program code configured to receive indication to associate a first video image with a second video image, wherein the first and second video images include respective images of a subject, associate the first video image, the second video image and an angle of the second video image relative to the first video image, cause the apparatus to cause display of the first video image including an image of a subject, receive indication to change a viewing angle relative to the subject, and cause display of the second video image associated with the first video image including an image of the subject based on the indication to change the viewing angle. The indication to change the angle may be given by a movement of a device such as tilting, or bending. Additionally or alternatively, the indication to change the angle may be received by detecting a gaze of a user, and/or by user selection of an object of interest. In some embodiments, the apparatus may receive an indication to associate the first and second video images with an angle of the second video image relative to the first video image, and associate the first video image, second video image, and the angle. According to some embodiments, the apparatus may receive indication to change a zoom level or cropping of an image, and cause display of the video image to change based on the indication. In some embodiments, the indication is a change in position of a device relative to a position of a virtual space.

In some embodiments, a computer program product is provided comprising at least one non-transitory computer-readable storage medium having computer-executable program code instruction stored therein with the computer-executable program code instructions including program code instructions to associate a first video image with a second video image, wherein the first and second video images include respective images of a subject, associate the first video image, the second video image and an angle of the second video image relative to the first video image, cause display of a first video image including an image of a subject, receive indication to change a viewing angle relative to the subject, and cause display of a second video image associated with the first video image including an image of the subject based on the indication to change the viewing angle. The indication to change the angle may be given by a movement of a device such as tilting or bending. Additionally or alternatively, the indication to change the angle may be received by detecting a gaze of a user, and/or by user selection of an object of interest. In some embodiments, the computer program code instructions may receive an indication to associate the first and second video images with an angle of the second video image relative to the first video image, and associate the first video image, second video image, and the angle.

In some embodiments, an apparatus is provided with means for receiving indication to associate a first video image with a second video image, wherein the first and second video images include respective images of a subject, associating the first video image, the second video image and an angle of the second video image relative to the first video image, causing display of the first video image including an image of a subject, receiving indication to change a viewing angle relative to the subject, and causing display of the second video image associated with the first video image including an image of the subject based on the indication to change the viewing angle.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an angular viewpoint apparatus that may be configured to implement example embodiments of the present invention;

FIG. 2 is a flowchart illustrating operations to configure an angular viewpoint apparatus in accordance with one embodiment of the present invention;

FIG. 3 is a flowchart illustrating operations to display video images using an angular viewpoint apparatus in accordance with one embodiment of the present invention;

FIG. 4 is a block diagram illustrating an example configuration of devices for capturing video images to be provided by an angular viewpoint apparatus, and FIGS. 4A-4C illustrate example views from the devices of FIG. 4 in accordance with one embodiment of the present invention; and

FIGS. 5A-7B illustrate displays and corresponding positions of user terminals relative to a position in a virtual space.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

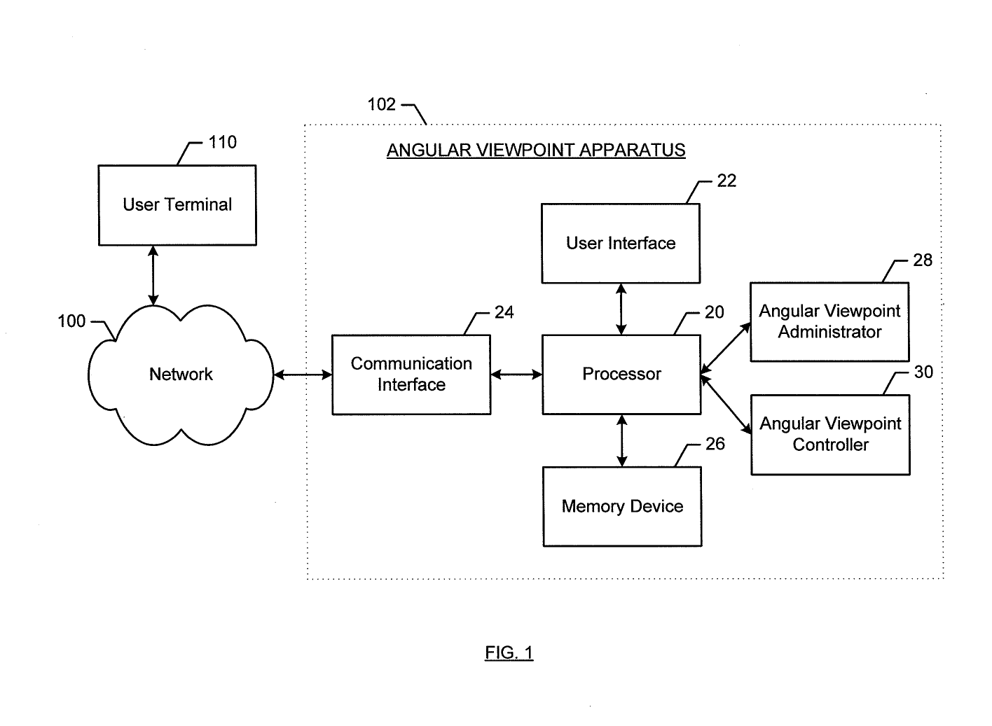

As described below, a method, apparatus and computer program product are provided for viewing video images captured from different angles of a common subject. In this regard, a subject may be a person, a group of people, scenery, an event, an object, or anything captured by video footage. Referring to FIG. 1, angular viewpoint apparatus 102 may include or otherwise be in communication with processor 20, user interface 22, communication interface 24, memory device 26, angular viewpoint administrator 28, and angular viewpoint controller 30. Angular viewpoint apparatus 102 may be embodied by a wide variety of devices including mobile terminals, e.g., mobile telephones, smartphones, tablet computers laptop computers, or the like, computers, workstations, servers or the like and may be implemented as a distributed system or a cloud based entity.

In some embodiments, the processor 20 (and/or co-processors or any other processing circuitry assisting or otherwise associated with the processor 20) may be in communication with the memory device 26 via a bus for passing information among components of the angular viewpoint apparatus 102. The memory device 26 may include, for example, one or more volatile and/or non-volatile memories. In other words, for example, the memory device 26 may be an electronic storage device (e.g., a computer readable storage medium) comprising gates configured to store data (e.g., bits) that may be retrievable by a machine (e.g., a computing device like the processor 20). The memory device 26 may be configured to store information, data, content, applications, instructions, or the like for enabling the apparatus to carry out various functions in accordance with an example embodiment of the present invention. For example, the memory device 26 could be configured to buffer input data for processing by the processor 20. Additionally or alternatively, the memory device 26 could be configured to store instructions for execution by the processor 20.

The angular viewpoint apparatus 102 may, in some embodiments, be embodied in various devices as described above. However, in some embodiments, the angular viewpoint apparatus 102 may be embodied as a chip or chip set. In other words, the angular viewpoint apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The angular viewpoint apparatus 102 may therefore, in some cases, be configured to implement an embodiment of the present invention on a single chip or as a single “system on a chip.” As such, in some cases, a chip or chipset may constitute means for performing one or more operations for providing the functionalities described herein.

The processor 20 may be embodied in a number of different ways. For example, the processor 20 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 20 may include one or more processing cores configured to perform independently. A multi-core processor may enable multiprocessing within a single physical package. Additionally or alternatively, the processor 20 may include one or more processors configured in tandem via the bus to enable independent execution of instructions, pipelining and/or multithreading.

In an example embodiment, the processor 20 may be configured to execute instructions stored in the memory device 26 or otherwise accessible to the processor 20. Alternatively or additionally, the processor 20 may be configured to execute hard coded functionality. As such, whether configured by hardware or software methods, or by a combination thereof, the processor 20 may represent an entity (e.g., physically embodied in circuitry) capable of performing operations according to an embodiment of the present invention while configured accordingly. Thus, for example, when the processor 20 is embodied as an ASIC, FPGA or the like, the processor 20 may be specifically configured hardware for conducting the operations described herein. Alternatively, as another example, when the processor 20 is embodied as an executor of software instructions, the instructions may specifically configure the processor 20 to perform the algorithms and/or operations described herein when the instructions are executed. However, in some cases, the processor 20 may be a processor of a specific device (e.g., a mobile terminal or network entity) configured to employ an embodiment of the present invention by further configuration of the processor 20 by instructions for performing the algorithms and/or operations described herein. The processor 20 may include, among other things, a clock, an arithmetic logic unit (ALU) and logic gates configured to support operation of the processor 20.

Meanwhile, the communication interface 24 may be any means such as a device or circuitry embodied in either hardware or a combination of hardware and software that is configured to receive and/or transmit data from/to a network and/or any other device or module in communication with the angular viewpoint apparatus 102. In this regard, the communication interface 24 may include, for example, an antenna (or multiple antennas) and supporting hardware and/or software for enabling communications with a wireless communication network. Additionally or alternatively, the communication interface 24 may include the circuitry for interacting with the antenna(s) to cause transmission of signals via the antenna(s) or to handle receipt of signals received via the antenna(s). In some environments, the communication interface 24 may alternatively or also support wired communication. As such, for example, the communication interface 24 may include a communication modem and/or other hardware/software for supporting communication via cable, digital subscriber line (DSL), universal serial bus (USB) or other mechanisms.

In some embodiments, such as instances in which the angular viewpoint apparatus 102 is embodied by a user device, the angular viewpoint apparatus 102 may include a user interface 22 that may, in turn, be in communication with the processor 20 to receive an indication of a user input and/or to cause provision of an audible, visual, mechanical or other output to the user. As such, the user interface 22 may include, for example, a keyboard, a mouse, a joystick, a display, a touch screen(s), touch areas, soft keys, a microphone, a speaker, or other input/output mechanisms. Alternatively or additionally, the processor 20 may comprise user interface circuitry configured to control at least some functions of one or more user interface elements such as, for example, a speaker, ringer, microphone, display, and/or the like. The processor 20 and/or user interface circuitry comprising the processor 20 may be configured to control one or more functions of one or more user interface elements through computer program instructions (e.g., software and/or firmware) stored on a memory accessible to the processor 20 (e.g., memory device 26, and/or the like).

In some example embodiments, processor 20 may be embodied as, include, or otherwise control an angular viewpoint administrator 28 for configuring video images to be viewed from different angles. As such, the angular viewpoint administrator 28 may be embodied as various means, such as circuitry, hardware, a computer program product comprising computer readable program instructions stored on a computer readable medium (for example, memory device 26) and executed by a processing device (for example, processor 20), or some combination thereof. Angular viewpoint administrator 28 may be capable of communication with one or more of the processor 20, memory device 26, user interface 22, and communication interface 24 to access, receive, and/or send data as may be needed to perform one or more of the angular viewpoint administration functionalities as described herein.

Angular viewpoint apparatus 102 may include, in some embodiments, an angular viewpoint controller 30 configured to perform functionalities as described herein, such as providing displays of video images from different angles. Processor 20 may be embodied as, include, or otherwise control the angular viewpoint controller 30. As such, the angular viewpoint controller 30 may be embodied as various means, such as circuitry, hardware, a computer program product comprising computer readable program instructions stored on a computer readable medium (for example, the memory device 26) and executed by processor 20, or some combination thereof. Angular viewpoint controller 30 may be capable of communication with one or more of the processor 20, memory device 26, user interface 22, communication interface 24, and angular viewpoint administrator 28 to access, receive, and/or send data as may be needed to perform one or more of the functionalities of the angular viewpoint controller 30 as described herein. Additionally, or alternatively, angular viewpoint controller 30 may be implemented on angular viewpoint administrator 28. In some example embodiments in which angular viewpoint apparatus 102 is embodied as a server cluster, cloud computing system, or the like, angular viewpoint administrator 28 and angular viewpoint controller 30 may be implemented on different apparatuses.

Any number of user terminal(s) 110 may connect to angular viewpoint apparatus 102 via a network 100. User terminal 110 may be embodied as a mobile terminal, such as personal digital assistants (PDAs), pagers, mobile televisions, mobile telephones, gaming devices, laptop computers, tablet computers, cameras, camera phones, video recorders, audio/video players, radios, global positioning system (GPS) devices, navigation devices, or any combination of the aforementioned, and other types of voice and text communications systems. The user terminal 110 need not necessarily be embodied by a mobile device and, instead, may be embodied in a fixed device, such as a computer or workstation. Network 100 may be embodied in a local area network, the Internet, any other form of a network, or in any combination thereof, including proprietary private and semi-private networks and public networks. The network 100 may comprise a wire line network, wireless network (e.g., a cellular network, wireless local area network, wireless wide area network, some combination thereof, or the like), or a combination thereof, and in some example embodiments comprises at least a portion of the Internet. As another example, a user terminal 110 may be directly coupled to an angular viewpoint apparatus 102.

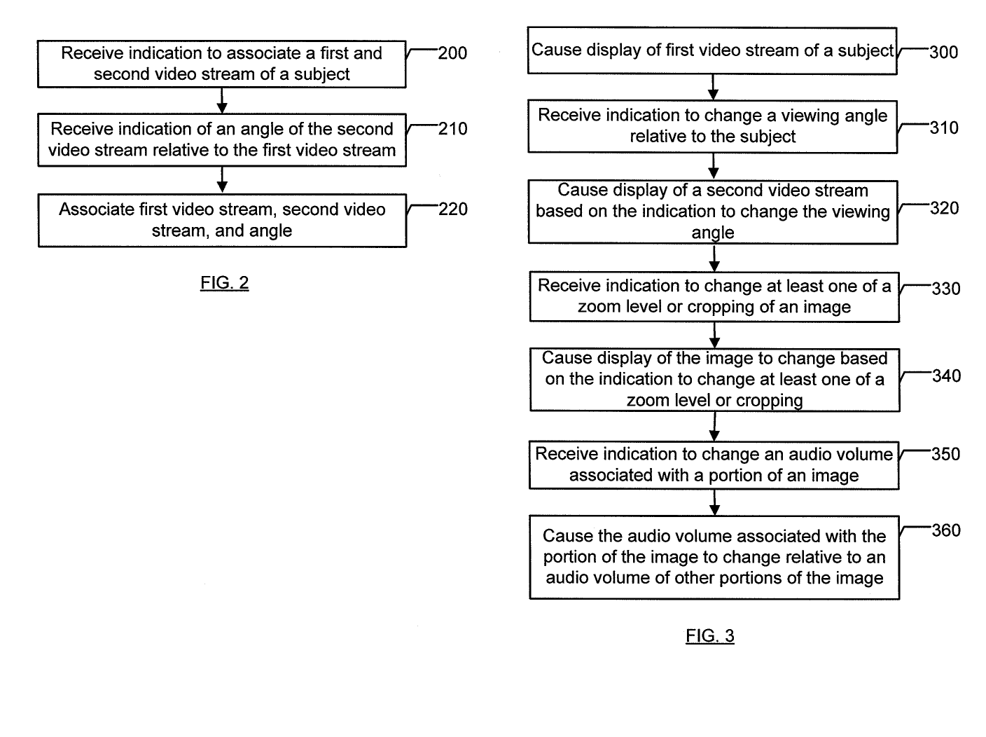

Referring now to FIG. 2, the operations for configuring video images for changing angular viewpoints are outlined in accordance with one example embodiment. In this regard and as described below, the operations of FIG. 2 may be performed by the angular viewpoint administrator 28. The angular viewpoint apparatus 102 may include means, such as the processor 20, communication interface 24 or the like, for receiving an indication to associate a first and second video image including a subject, as shown in operation 200. In this regard, a video image may be stored on a local memory device, such as memory device 26, may be received via communication interface 24, and/or may be streamed over network 100 from an apparatus, server, database, or the like, other than the angular viewpoint apparatus 102. In some embodiments, a first video image including the subject may have been previously provided by a user, and a second video image including the subject, may be subsequently provided by another user. The indication to associate the first and second video images may be initiated as a user input at user terminal 110, transmitted via network 100, for example, and received by communication interface 24. Additionally or alternatively, an indication may be provided via user interface 22. In other embodiments, the indication may be generated automatically, such as in a batch routine stored on memory device 26, for example, and performed by processor 20, angular viewpoint administrator 28, or the like. In such an instance, any component of the angular viewpoint apparatus 102 may recognize that two video images should be associated due to their capture of the same subject, which may be detected by a variety of means, such as detection of like user-provided attributes, such as a concert name, date and venue, by object recognition, or otherwise. In some embodiments, video coding methods may allow associated video images to be compressed or coded to be saved as one file. Additionally or alternatively, associated video images may be stored as separate files.

As shown in operation 210, angular viewpoint apparatus 102 may include means, such as the processor 20, communication interface 24, or the angular viewpoint administrator 28 for receiving an indication of an angle of the second video image relative to the first video image. The indication may be initiated as a user input at user terminal 110, transmitted via network 100, for example, and received by communication interface 24. In some embodiments, an indication may be provided via user interface 22. The indication may comprise quantifiable measures of an angle, such as coordinates and/or angles, and may represent a 2-dimensional or 3-dimensional angle measure. An indication may include a user input such as a click or drag of a mouse or other indicator relative to the first video image in order for a user to indicate an angle the second video image is captured from relative to the first video image. Additionally or alternatively, angular viewpoint administrator 28, processor 20, or the like, may automatically detect an angle of the second video image relative to the first video image, such as by object recognition and/or detection. In some embodiments, an angle measurement may not be provided.

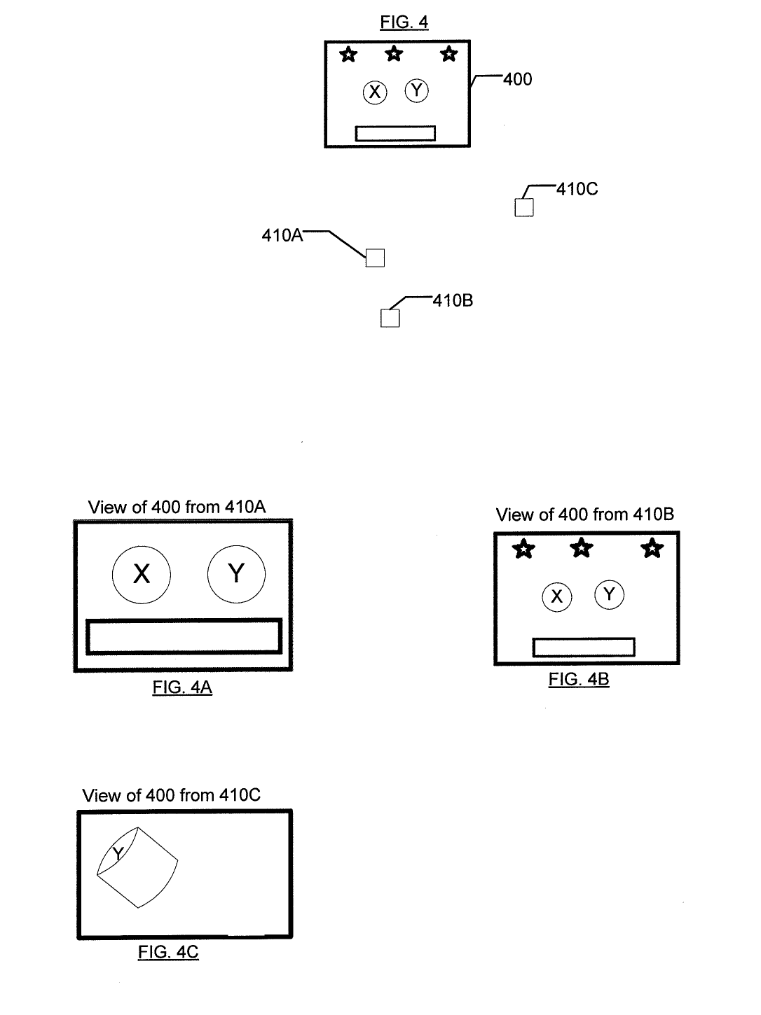

Continuing to operation 220, angular viewpoint apparatus 102, may include means, such as angular viewpoint administrator 28, for associating the first video image, second video image, and angle in a database or memory device 26, for example. An association may be made by storing an indication of the angle, and references to the first and second video images. The first and second video images may be stored on a different memory device from the memory device storing association references, or they may be stored on the same memory device. In some embodiments, a two-way association may exist. For example, a first video image may reference a second video image, and the second video image may reference the first video image. According to some embodiments, a one-way association may be established. As such, a first video image may reference a second video image, but the second video image may not necessarily reference the first video image. In some embodiments, angular viewpoint administrator 28 may not have access to a relative angle, and may associate the first and second video images as being of the same subject captured from different angles, without indicating from what angle the second video image is captured. It will be appreciated that any number of video images may be associated, and that associations may allow the angular viewpoint controller 30 to provide video images of a subject captured from different angles, as described in regard to FIG. 3.

FIG. 3 is a flowchart illustrating operations for displaying video images using an angular viewpoint apparatus 102. At operation 300, angular viewpoint apparatus 102 may include means, such as the processor 20 or the angular viewpoint controller 30 for causing display of a first video image of a subject. A user may access the first video image via a network 100 and communication interface 24, and view the first video image from a web browser on a user terminal 110, for example. The video image may be stored on memory device 26 and/or streamed from another server or device. The video image may additionally or alternatively be provided as a live video stream from a device such as a user terminal 110.

At operation 310, the angular viewpoint apparatus 102 may include means, such as the processor 20 or angular viewpoint controller 30 for receiving an indication to change a viewing angle relative to the subject. Such an indication may be provided by a user on user terminal 110, for example, and may comprise selecting and/or dragging an indicator such as a mouse or stylus in a way that indicates the user would like to view the subject from another angle. In some embodiments, the angular viewpoint controller 30 may provide selections of available video images, and may provide an indication of an angle from which the video is captured. Thus, a user may select one of the available video images based on the angle from which it is captured.

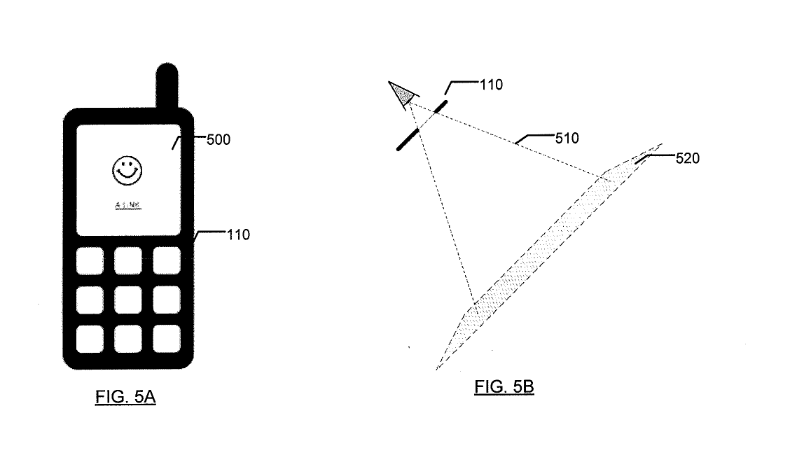

Available video images may be captured and provided to angular viewpoint apparatus 102, or may be streamed to angular viewpoint apparatus 102 or user terminal 110 real-time. Various video images may be captured from a configuration of devices such as illustrated in FIG. 4. Subject 400 may represent a stage at a concert, for example. Any number of devices 410, such as camera, mobile devices, computers, or any device capable of capturing video images, may be positioned in various locations relative to subject 400. In the example configuration of FIG. 4, three devices represented by 410A, 410B, and 410C, are provided. As such, the video images captured by the devices 410A-C may be provided to angular viewpoint apparatus 102 so that the various video images, captured from different angles, may be made available to users. For example, FIG. 4A illustrates and example view of subject 400 captured by device 410A. FIG. 4B illustrates and example view of subject 400 captured by device 410B. Comparing FIGS. 4A and 4B illustrates varying zoom levels of the devices 410A and 410B. FIG. 4C illustrates and example view of subject 400 captured by device 410C. The viewing angle is substantially different from the video image of devices 410A and 410B. The zoom level of device 4C is also configured to zoom in on subject 400 more so than device 410B.

In some embodiments, such as those in which user terminal 110 is embodied as a mobile device, the indication to change the viewing angle in accordance with operation 310, may be received by detecting a movement of a device. In this regard, the mobile device may also include a sensor, e.g., a gyroscope and/or an accelerometer, to provide an indication regarding a movement of the device to the angular viewpoint controller 30, or the like. For example, the processor 20 or angular viewpoint controller 30 may detect tilting of a device, or bending of a flexible device. In some embodiments, a sensor on the device may detect a user's eyes gazing at a portion of the video image, and may interpret the gaze to be an indication to change the viewing angle. Additionally or alternatively, the indication may comprise receiving selection of an object of interest within the viewing area.

At operation 320, in response to receiving indication to change a viewing angle, angular viewpoint controller 30 may cause display of a second video image of the subject. The second video image may be identified by the processor 20 or angular viewpoint controller 30 and may be accessed by identifying associations with the first video image as stored in memory device 26, for example. The display of the second video image may replace the display of the first video image, or the second video image may be displayed in addition to the first video image. The second video image may be stored on memory device 26 and/or streamed from another server or device. The second video image may additionally or alternatively be provided as a live video stream from a device such as a user terminal 110. Any number of associated video images may be displayed. In instances in which multiple associated video images are available, angular viewpoint controller 30 may base the selection of the second video image on an indication of a preferred angle provided by a user, such as provided with respect to operation 310. Additionally or alternatively, the processor 20 or angular viewpoint controller 30 may randomly identify the second video image, and/or identify it based on any other information.

In some embodiments, the angular viewpoint controller 30 may begin display of the second video image at a point in time of the first video image when the indication to change a viewing angle was received. More specifically, the first and second video images may have an associated start time at which the video capture began, and a starting point of the second video image at which to begin displaying the second video image may be identified by comparing the timing of the first video image when the indication to change a viewing angle was received to the timestamp of the second video image, and adjusting the starting point of the second video image accordingly. Such embodiments may be useful in video images where continuous audio feed is important such as speeches and/or concerts, for example. Additionally or alternatively, the processor 20 or the angular viewpoint controller 30 may start the display of the second video image at any point in time. In some embodiments, audio associated with the first video image may be provided, while the images of the second video image are displayed. Additionally or alternatively, the provided audio may change to the second video image at the same time the display is changed. In some embodiments, audio may not be provided.

Continuing to operation 330, in some embodiments, the angular viewpoint apparatus 102 may include means, such as the processor 20 or angular viewpoint controller 30 for receiving indication to change a zoom level and/or cropping of the image. The indication may be initiated at user terminal 110 and communicated to the angular viewpoint apparatus 102 via network 100 and communication interface 24, for example. At operation 340, the angular viewpoint apparatus 102, may include means, such as the processor 20 or the angular viewpoint controller for causing display of the image to change based on the indication to change a zoom level or cropping. Combining angular viewpoint selection with zooming and/or cropping may provide for a customizable viewing experience so that the user may view a subject from a preferred angle, and with a preferred zoom level and cropping.

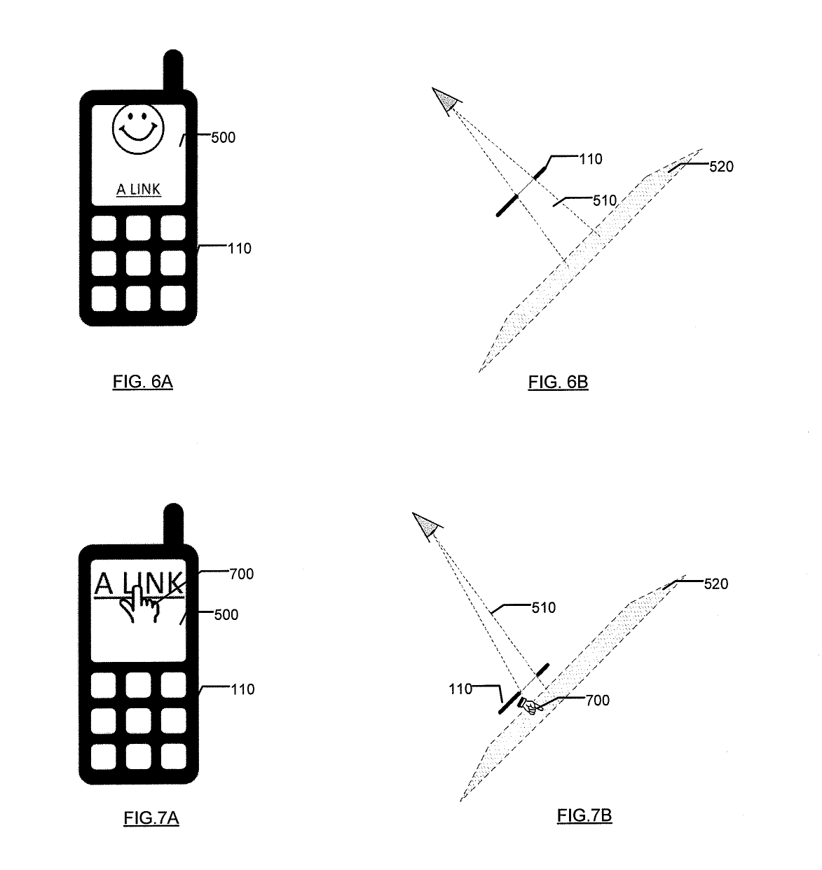

In some embodiments, the indication to change a zoom level may be received by movement of a device relative to a position in a virtual space, such as illustrated by FIG. 5A-7B. A display 500 of a user terminal 110, such as a mobile device is illustrated by FIGS. 5A, 6A, and 7A. FIGS. 5B, 6B, and 7B illustrate example positions of user terminal 110 relative to a position in a virtual space 520, the resulting viewing area 510 providing indication to change a zoom level. The position in a virtual space 520 may not be an actual surface, but a position in space some distance away from user terminal 110 while a user is viewing an image or video. The user terminal 110 may be considered as a window to the position in a virtual space 520. The viewing area 510 is controlled by moving the user terminal 110 back, forth, and/or sideways. A movement such as this may be an indication to change a zoom level. For example, the initial position of user terminal 110 in FIG. 5B results in a display 500 of FIG. 5A. If the user terminal 110 is moved forward, such as in FIB. 6B, the corresponding viewing area 510 narrows, and display 500 of FIG. 6A may be zoomed in. Continuing to FIG. 7B, the user terminal 110 is moved closer to the position in a virtual space 520, further narrowing the viewing area 510, and further narrowing the display 500 of FIG. 7A. Additionally or alternatively, as illustrated in FIG. 7B, if there are selectable objects displayed in the image, objects may be selected by moving the small device so much forward that it is aligned with the position in a virtual space 520. The small display of the device may contain a pointer 700, illustrated in FIGS. 7A and 7B, to help in these actions.

At operation 350, the angular viewpoint apparatus 102 may include means, such as the processor 20 or the angular viewpoint controller for receiving indication to change an audio volume associated with a portion of an image. The indication may be initiated at user terminal 110 and may be communicated to the angular viewpoint apparatus 102 via network 100 and communication interface 24, for example. The indication may comprise selection by mouse, stylus, touch, or similar means of a portion of a viewing area or image, such as a member of a band during a performance. At operation 360, the angular viewpoint apparatus 102 may include means, such as the processor 20 or the angular viewpoint controller 30 to cause an audio volume associated with the portion of the image to change relative to an audio volume of other portions of the image. Separate audio tracks may be provided and associated with different areas of an image displayed in a video image. For example, selecting a singer may result in the audio volume of the singer's voice changing in volume comparison to the audio volume of sounds created by other band members.

As described above, FIGS. 2 and 3 illustrate flowcharts of operations performed by an angular viewpoint apparatus 102. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 26 of an angular viewpoint apparatus 102 employing an embodiment of the present invention and executed by a processor 20 of the angular viewpoint apparatus 102. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-33. (canceled)

34. A method comprising:
receiving indication to associate a first video image with a second video image, wherein the first and second video images include respective images of a subject;
associating the first video image, the second video image and an angle of the second video image relative to the first video image;
causing display of the first video image;
receiving indication to change a viewing angle relative to the subject; and
causing, by a processor, display of the second video image associated with the first video image including an image of the subject based on the indication to change the viewing angle.

35. A method according to claim 1, wherein the receiving indication to change the viewing angle comprises at least one of:
detecting tilting of a device;
detecting bending of a device;
detecting a gaze of a user; or
receiving selection of an object of interest.

36. A method according to claim 1, further comprising:
receiving indication of the angle of the second video image relative to the first video image; and
associating the first video image, second video image, and the angle of the second video image relative to the first video image.

37. A method according to claim 1, further comprising:
receiving indication to change an audio volume associated with a portion of an image; and
causing the audio volume associated with the portion of the image to change relative to an audio volume of other portions of the image based on the indication to change the audio volume.

38. A method according to claim 1, further comprising:
receiving indication to change at least one of a zoom level or cropping of an image; and
causing display of the video image to change based on the indication to change at least one of the zoom level or cropping.

39. A method according to claim 5, wherein the indication is a change in position of a device relative to a position of a virtual space.

40. A method according to claim 1, wherein a start point of the display of the second video image is based on a point in time of the first video image when the indication to change a viewing angle was received.

41. An apparatus comprising at least one processor and at least one memory including computer program code, the at least one memory and the computer program code configured to, with the processor, cause the apparatus to at least:
receive indication to associate a first video image with a second video image, wherein the first and second video images include respective images of a subject;
associate the first video image, the second video image and an angle of the second video image relative to the first video image;
cause display of the first video image;
receive indication to change a viewing angle relative to the subject; and
cause display of the second video image associated with the first video image including an image of the subject based on the indication to change the viewing angle.

42. An apparatus according to claim 8, wherein the at least one memory and the computer program code are further configured to, with the processor, cause the apparatus to at least receive indication to change the viewing angle by performing at least one of:
detecting tilting of a device;
detecting bending of a device;
detecting a gaze of a user; or
receiving selection of an object of interest.

43. An apparatus according to claim 8, wherein the at least one memory and the computer program code are further configured to, with the processor, cause the apparatus to at least:
receive indication of the angle of the second video image relative to the first video image; and
associate the first video image, second video image, and the angle of the second video image relative to the first video image.

44. An apparatus according to claim 8, wherein the at least one memory and the computer program code are further configured to, with the processor, cause the apparatus to at least:
receive indication to change an audio volume associated with a portion of an image; and
cause the audio volume associated with the portion of the image to change relative to an audio volume of other portions of the image based on the indication to change the audio volume.

45. An apparatus according to claim 8, wherein the at least one memory and the computer program code are further configured to, with the processor, cause the apparatus to at least:
receive indication to change at least one of a zoom level or cropping of an image; and
cause display of the video image to change based on the indication to change at least one of the zoom level or cropping.

46. An apparatus according to claim 12, wherein the indication is a change in position of a device relative to a position of a virtual space.

47. An apparatus according to claim 9, wherein a start point of the display of the second video image is based on a point in time of the first video image when the indication to change a viewing angle was received.

48. A computer program product comprising at least one non-transitory computer-readable storage medium having computer-executable program code instructions stored therein, the computer-executable program code instructions comprising program code instructions to:
receive indication to associate a first video image with a second video image, wherein the first and second video images include respective images of a subject;
associate the first video image, the second video image and an angle of the second video image relative to the first video image;
cause display of the first video image;
receive indication to change a viewing angle relative to the subject; and
cause display of the second video image associated with the first video image including an image of the subject based on the indication to change the viewing angle.

49. A computer program product according to claim 15, wherein the computer-executable program code instructions comprise program code instructions to receive indication to change the viewing angle by performing at least one of:
detecting tilting of a device;
detecting bending of a device;
detecting a gaze of a user; or
receiving selection of an object of interest.

50. A computer program product according to claim 15, wherein the computer-executable program code instructions further comprise program code instructions to:
receive indication of the angle of the second video image relative to the first video image; and
associate the first video image, second video image, and the angle of the second video image relative to the first video image.

51. A computer program product according to claim 15, wherein the computer-executable program code instructions further comprise program code instructions to:
receive indication to change an audio volume associated with a portion of an image; and
cause the audio volume associated with the portion of the image to change relative to an audio volume of other portions of the image based on the indication to change the audio volume.

52. A computer program product according to claim 15, wherein the computer-executable program code instructions further comprise program code instructions to:
receive indication to change at least one of a zoom level or cropping of an image; and
cause display of the video image to change based on the indication to change at least one of the zoom level or cropping.

53. A computer program product according to claim 15, wherein a start point of the display of the second video image is based on a point in time of the first video image when the indication to change a viewing angle was received.
